(19) United States
(12) Patent Application Publication
(10) Pub. No.: US 2010/0239137 A1
(43) Pub. Date: Sep. 23, 2010

(54) Two Dimensional Imaging of Reacted Areas On a Reagent

(75) Inventors: Michael J. Pugia, Granger, IN (US); James A. Profitt, Goshen, IN (US); Chris T. Zimmerle, Goshen, IN (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Healthcare Diagnostics Inc., Tarrytown, NY (US)

(21) Appl. No.: 12/681,180

(22) PCT Filed: Oct. 6, 2008
(86) PCT No.: PCT/US08/78906

§ 371 Date: Apr. 1, 2010

Related U.S. Application Data
(60) Provisional application No. 60/978,505, filed on Oct. 9, 2007.

(51) Int. Cl. G06K 9/00; H04N 7/18

(52) U.S. Cl. 382/128; 348/135; 348/E07.085

(57) ABSTRACT

A system for reading an assay includes a camera and a processor. The assay is used as a test for the presence or absence of a reaction between a sample and a reagent. The assay is defined by a test area and a background area. The test area is, preferably, substantially circular with a diameter between about 0.1 mm and about 5 mm. The camera simultaneously captures a two-dimensional image of the test area and the background area. The processor determines a first color response from the background area and a second color response from the test area. The processor then calibrates the second color response according to the first color response and generates a result of the test according to the second color response. The system may also include a uniform field illuminator that provides a substantially uniform level of illumination across the assay.

### TECHNOLOGY FIELD

The subject matter described herein relates generally to imaging, and in particular to reading an assay. This technology is particularly suited, but by no means limited, for use by businesses in the medical diagnostic equipment.

### BACKGROUND

Generally, diagnostic equipment may use assays to determine the presence or absence of a particular compound and/or measure a particular characteristic of a biological sample. For example, the sample may be placed on a dry reagent assay, the sample may react with the dry reagent, and the reacted area may change color. Diagnostic equipment may measure this color change, as reflectance, to determine a result of the test.

Diagnostic equipment may use charge coupled devices (CCD), such as CCD cameras, to measure the reflectance. Generally, the reaction area for reading a dry reagent assay may be about 25 mm² The reaction area may vary within a range of generally 10 mm² to 100 mm² Although the increasing resolution of CCD imaging technology may enable using smaller reaction areas, which may use less volume sample and costly liquid reagents, there are other significant technological barriers that make it difficult to use smaller reaction areas in diagnostic applications.

Small reaction areas may be used in diagnostic equipment that employ micro fluidic dispensing of a sample. As a result of the small size, the color of the reacted reagent generates much less signal when read by a CCD imaging device than may be normally encountered with a larger reaction area. Measuring such small signals may be difficult because of the associated low signal to noise ratio (SNR). A low SNR may make the reading ineffective for providing an accurate result to the diagnostic test.

Because there may be many contributors to noise, the noise tends to outweigh the small signal received from the small reaction area. First, interference may be introduced by irregularities in the texture and height differences between different test surfaces of dry reagent assays. Differences in texture and height may result from different materials and different manufacturing techniques used when producing the assays. For example, a type of filter paper may have a unique texture and thickness. Thickness of the reagent may vary and the surface may not be smooth. The light that reflects from this irregular surface to be read by the CCD device often includes noise as a result of the irregular surface and height. This noise may be a major component of the SNR when reading small reacted reagent areas.

Second, interference may be introduced by light in the infrared wavelengths. There is often an unpredictable amount and quality of infrared light in a typical testing environment Infrared light may strongly affect the measurements of the CCD device because CCD devices may be particularly sensitive to infrared light.

Third, the reagent may move relative to the CCD during reading or may not be in optimal position relative to the CCD device. The image quality, and consequently the accuracy, of the color reading made by the CCD device may diminish when the reagent moves during the reading. When the reagent is not the proper distance to the CCD, the image may be out of focus. This interference may be exacerbated when the reacted reagent area is very small. Furthermore, difficulties with positioning tolerance may become much more pronounced when the reacted reagent area is small.

Separately and in combination, these interferences increase noise and diminish the SNR. These interferences may be particularly troublesome when the reacted reagent area is small. Moreover, the signal received from a small reagent area is diminished on account of its small size. Therefore, there is a need in the art for a system that overcomes the diminished signal and the increases in noise associated with small reaction areas to establish a SNR suitable for accurate diagnostic equipment.

### SUMMARY

An assay may be used as a test for the presence or absence of a reaction between a sample and a reagent. The assay may have a dry reagent that defines a test area and a background area. The test area may be substantially circular with a diameter between about 0.1 mm and 5 mm. The sample may be dispensed at the test area such that the test area of the reagent is in contact with the sample.

A system for reading the assay is disclosed. The system includes a camera and a processor. The camera simultaneously captures a two-dimensional image of the test area and the background area. The camera may be a charge-coupled device (CCD) camera.

The processor smoothes the two-dimensional image with a filter. The processor determines, from the two-dimensional image, a first color response from the background area and a second color response from the test area or vice versa. The processor calibrates the second color response according to the first color response and generates a result of the test according to the second color response.

The processor determines the first color response by segmenting the two-dimensional image into a plurality of columns. The processor determines a first column from the plurality of columns that has the greatest color response and segments the first column into a plurality of sections. The processor then determines a first section from the plurality of sections that has the greatest color response. Generally, the first section corresponds with the center of the test area.

The system may also include a uniform field illuminator that provides a substantially uniform level of illumination across the test area and the background area. The uniform field illuminator may include a circular array of light emitting diodes around the camera. The circular array of light emitting diodes preferably include any light emitting diode from about 400 nm to about 1500 nm.

The uniform field illuminator may provide infrared (IR) light. In this embodiment, the camera captures an IR calibration image while the assay is illuminated with the infrared light, and the processor normalizes the two-dimensional image with the IR calibration image.

The uniform field illuminator may be in communication with the processor. In this embodiment, the processor directs the uniform field illuminator to illuminate the assay with a sequence of different frequencies of light. The processor then directs the camera to capture a sequence of images corresponding to the sequence of frequencies of light. Finally, the processor determines the second color response from the sequence of images.

The camera may capture a luminance linearity calibrating image, and the processor may adjust the gamma function of the camera according to the luminance linearity calibrating image.

The camera may capture a plurality of two-dimensional images of the test area and the background area. For example, the camera may capture the plurality of two-dimensional images at a rate substantially about 90 frames per second. The processor may average the plurality of two-dimensional images.

The system may also include a receiving area that is adapted to receive any of a strip, cassette, card, and micro-fluidic assay format. For example, the format may include reagent to assay metabolites, proteins, enzymes, nucleic acids, bacteria, human cells, crystals and particles. The receiving area may be in communication with the processor. The processor may direct the receiving area to move the assay relative to a field of view of the camera.

The assay may define a plurality of test areas. The field of view may encompass a first subset of the plurality of test areas. The receiving area may move the assay relative to the field of view such that the field of view encompasses a second subset of the plurality of test areas. Each test area may include a sample from multiple patients and/or from different dispensing times.

Additional features and advantages of the invention will be made apparent from the following detailed description of illustrative embodiments that proceeds with reference to the accompanying drawings.

### BRIEF DESCRIPTION OF THE DRAWINGS

FIG. 1 depicts a block diagram of an exemplary system for reading an assay;

FIGS. 2A & 2B depict an exemplary reagent with multiple reacted areas with a field of view in a first and second position, respectively;

FIGS. 3A & 3B depict an exemplary uniform field illuminator in side view with camera and in frontal view without camera, respectively;

FIG. 4 depicts an exemplary process flow for reading an assay;

FIG. 5 depicts an exemplary process for determining a color response from a reacted area of reagent; and

FIG. 6 depicts an exemplary user interface for displaying a result from reading an assay.

### DETAILED DESCRIPTION

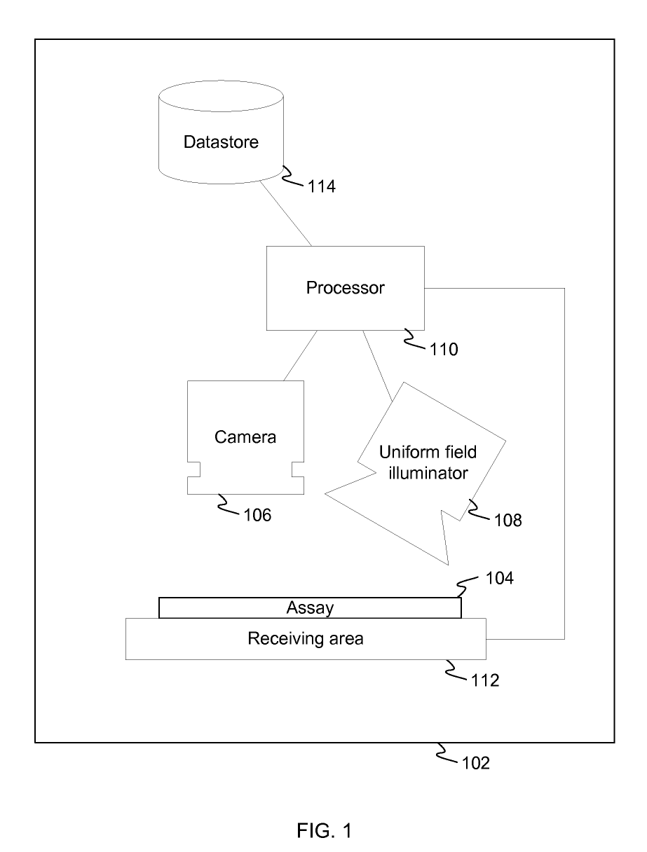

FIG. 1 depicts a block diagram of an exemplary system 102 for reading an assay 104. The system 102 for reading an assay 104 includes a camera 106 and a uniform field illuminator 108 in communication with a processor 110. The system 102 also includes a receiving area 112 that secures the assay 104 and a data store 114. The receiving area 112 and the data store 114 may be in communication with the processor 110.

The assay 104 may be any diagnostic test medium suitable for detecting the presence or absence of a compound and/or for determining a characteristic of a biological sample by a reaction with a dry reagent that affects the reflectance of the dry reagent. For example, the assay 104 may include a reagent, that when reacted, with biological urine sample, may detect glucose, creatinine, albumin, protein, occult blood, urobilinogen, pH, ketone, specific gravity, bilirubin, leukocyte, nitrite, and the like. The assay 104 may be in strip, cassette, and card format. The assay 104 may have dispensed on it a sample. The dispensed sample may have a volume in micron sized droplets. Small droplets may allow the developed reagent colors to be uniform as the sample itself is uniformly absorbed into the reagent paper. The sample may be dispensed in cycles of around 100 to 3000 droplets on to a small reagent target area. In an embodiment, the reacted reagent area may be substantially circular between about 0.1 mm and 5 mm in diameter (and/or the area equivalent). In an embodiment, the reacted reagent area may be substantially rectangular. For example, the reacted reagent area may be about 0.008 mm² to about 20 mm² The assay 104 may have one or more areas in which the sample may be dispensed. Some diagnostic tests may be sensitive to the amount of time the sample has been in contact with the reagent. The one or more areas in which the sample may be dispensed may correlate to varying reaction durations. Once the sample has reacted with the reagent, the resultant reacted reagent may display a color different than the surrounding unreacted reagent. The reflectance of the reacted reagent may indicate the presence or absence of a compound and/or a characteristic of a biological sample. The system 102 may measure this reflectance to determine a result of the diagnostic test.

The camera 106 may be any device suitable for capturing a two-dimensional image of the reagent target area. In an embodiment, the camera 106 may include scanner optics such as a one-dimensional charged couple device (CCD) scanner that may be moved across the reagent target area to generate a two-dimensional image. For example, image information captured by the scanner as it moves may be used to produce a two-dimensional image. The one-dimensional scanner may facilitate even light intensity since the scanner area may be compact, reducing the area to be illuminated.

In an embodiment, a two-dimensional CCD digital camera 106 may capture a two-dimensional image of the reagent target area. A charge-coupled device (CCD) may be an image sensor that includes an array of coupled, light-sensitive capacitors. The capacitors may be packaged with an integrated circuit. In an embodiment, the CCD may be a ICX098BQ CCD (Sony, Corp. Tokyo, Japan). Other image sensors may include the CMOS VL6624/VS6624 image device (ST Microelectronics, Geneva, Switzerland). For example, the camera 106 may have a full-frame, frame-transfer and/or interline CCD architecture. The camera 106 may capture one or more images at any frame rate. In an embodiment, the camera 106 may have a frame rate up to 90 frames per second. The frames may be added to each other and an average taken to reduce the overall measurement noise. Faster frame rates may allow more averaging to take place per unit time. The images may be passed to the processor 110 for processing.

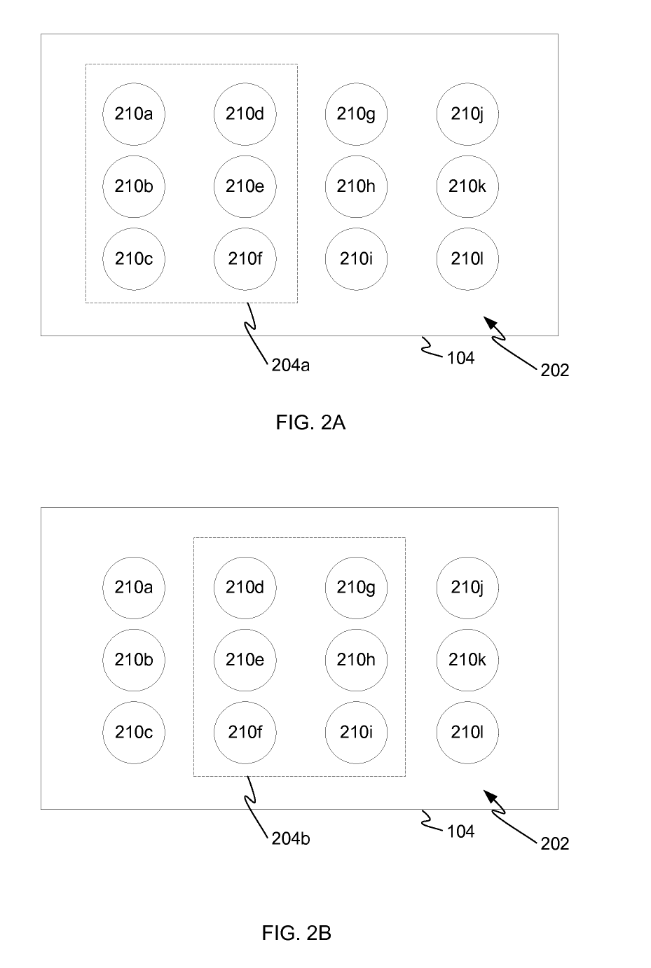

The camera 106 may be in connection with a lens. The lens and the camera 106 may define a field of view (see FIG. 2, 204a-b). For example, the lens may have one or more precision glass elements mounted in a housing. The lens may have a 5 mm length, an 8 mm length, a 25 mm length, and/or the like. The camera 106 may have a resolution related to the density of the CCD imager. In an embodiment, the camera 106 may have a 1.2 mega pixel resolution. The CCD may be positioned about 35 mm to about 5 mm from the assay 104. The combination of the CCD density and the distance to the assay 104 may provide the camera 106 a physical resolution of about 0.01 mm² to 0.5 mm² per pixel. The camera 106 may return a two-dimensional digital image. The digital image having pixels with corresponding red-green-blue color values. The ST VL6624NS6624 gives data in YUV, RGB or Bayer 8 bit and 10 bit formats. The resolution and color bit depth chosen may depend upon the accuracy needed. For example, a 24-bit color depth may be used.

The processor 110 may be any system, subsystem, and/or component suitable for processing image data. The processor 110 may be a general purpose microprocessor, an application specific integrated circuit, or the like. The processor 110 may control the operation of the camera 106, uniform field illuminator 108, and receiving area 112. For example, the processor 110 may direct the imaging characteristics of the camera 106, such as gamma function, frame rate, image capture, and the like. Also, the processor 110 may direct sequence, timing, and frequencies of light to be illuminated from the uniform field illuminator 108. In addition, the processor 110 may direct the receiving area 112 to move the assay 104 relative to the camera 106. In an embodiment, the processor 110 may direct the camera 106 to move relative to the receiving area 112.

The processor 110 may be a programmable device. The processor 110 may be a computer processor. The processor 110 may be within a computer, such as a personal computer, laptop computer, and the like. The processor 110 may be in communication with a human interface device. For example, the processor 110 may be in communication with a graphical display, keyboard, mouse, and the like. The processor 110 may be programmed according to computer executable instructions. The computer executable instructions may be stored on a computer readable medium. For example, the computer readable medium may include a flash memory, magnetic storage, optical storage such as a compact disc (CD) and/or digital versatile disc (DVD), and the like.

The processor 110 may process image data received from the camera 106. For example, the processor 110 may determine the color response associated with regions of the images received from the camera 106. The processor 110 may determine, for example, the red-green-blue color values of pixels within digital images received from the camera 106. The processor 110 may determine from the two-dimensional image received from the camera 106 a color response associated with an area of reacted reagent and/or a background area of unreacted reagent. The processor 110 may calibrate the color response of the reacted area according to the color response of the background area. The processor 110 may generate a result of the test for which the assay 104 is being used according to the color response of the reacted reagent.

In an embodiment, the processor 110 may be used to normalize the two-dimensional image received from the camera 106 with an infrared calibration image. The infrared calibration image may be captured by the camera 106 when the assay 104 and/or calibration card is illuminated with infrared light. The processor 110 may be used to adjust the translation characteristics of the CCD. For example, the processor 110 may be used to adjust the gamma function of the camera 106 according to a luminance linearity calibrating image. Where the camera 106 captures more than one image, the processor 110 may be used to combine the images into a single image. For example, the processor 110 may average data from the multiple images. The processor 110 may provide an image processing. For example, the processor 110 may smooth the image received from the camera 106 with a filter, such as a median filter and/or the like.

The processor 110 may be in communication with a datastore. The datastore may hold computer executable instructions. The datastore may store imaging data for processing by the processor 110. The datastore may store results generated by the processor 110. The datastore may be any system, subsystem, and/or component suitable for storing data. For example, the datastore may be flash memory, magnetic storage, random access memory (RAM), read only memory (ROM), processor 110 registers, at the like.

The uniform field illuminator 108 may be any illumination device suitable for providing near-uniform illumination across the camera's field of view on the reagent. For example, the near-uniform illumination may include a variation of less than about 2%. In an embodiment, a variation of up to about 10% may be used. Light from the uniform field illuminator 108 may be reflected from the surface of the assay 104 and read by the camera 106. The light from the uniform field illuminator 108 may reflect the color of the reacted reagent and the unreacted reagent, and this color may be captured as an image by the camera 106 and evaluated by the processor 110. The light from the uniform field illuminator 108 may be white light. In an embodiment, colored light with specific wavelengths may be used to enhance the color response for a given reacted reagent. Furthermore, a grey scale CCD may be used with colored light to detect and measure the reflectance of the illuminated wavelength.

In an embodiment, the uniform field illuminator 108 may be a square bar illuminator adapted to the camera 106. The light from such bar emitters may overlap such that the overlapping light profiles from each edge provide even illumination.

In an embodiment, the uniform field illuminator 108 may include a multiple wavelength-in-1 light emitting diode (LED) array. The multiple wavelength -in-1 LED array may include two or more LEDs emitting light from about 400 nm to about 1500 nm. The wavelengths may be selected to about capable of a detectable signal in the range. The multiple wavelength -in-1 LED array may allow a selector to enable any combination of the LED colors to be turned on and/or off continuously. The multiple wavelength -in-1 LED may employ fiber optics to route the light from the LED source to the assay 104. The fibers may be physically randomized such that the light is distributed evenly. In a further embodiment, a holographic dispersion insert may be used to even out intensity across the fibers.

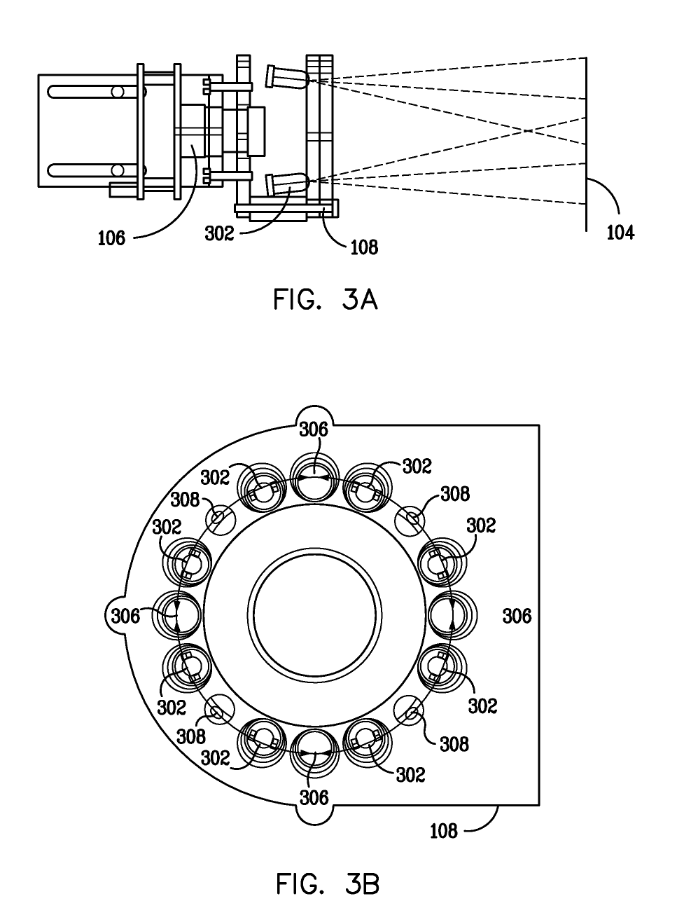

In an embodiment, the uniform field illuminator 108 may be a low-power incandescent lamp. The low-power incandescent lamp may provide sufficient illumination for a camera 106 at close range. The sensitivity of the camera 106 may be matched with the level of illumination provided by the uniform field illuminator 108 to provide adequate results. Furthermore, a lamp driven at low-power may be stable and may improve product lifetime. In an embodiment, the uniform field illuminator 108 may include an array of white, red, and infrared LED's (see FIGS. 3a & 3b).

The receiving area 112 may be adapted to receive any of a strip, cassette, card, and/or micro-fluidic chip assay format. For example, The micro-fluidic format may be a fluidic slide format and/or contain a separate and/or additional dry reagents. The processor 110 may direct the receiving area 112 to move the assay 104. The receiving area 112 may move such that the field of view of the camera 106 encompasses different areas of the assay 104. The receiving area 112 may move the assay 104 relative to the camera 106 from a first position to a second position.

A separate photodiode (not shown) may be added to the system to provide feedback settings for the camera 106. The camera settings may be adjusted based on the photodiode results

FIGS. 2A & 2B depict an exemplary reagent with multiple reacted areas with a field of view 204a-b in a first and second position respectively. The assay 104 may have a surface containing the dry reagent. The assay 104 may receive one or more samples and/or liquid reagent to be tested. The samples may be dispensed onto the dry reagent in a plurality of positions. These positions may establish a plurality of test areas 210a-1. The test areas 210a-1 may include areas of reagent in contact with the one or more samples. Thus, the assay 104 may have a dry reagent that defines test areas 210a-1 of reacted reagent and a background area 202 of reagent that has not been exposed to the sample. In a typical test with the assay 104, the color of the test area 210a-1 may change according to a reaction between the sample and the reagent. The color response of the test area 210a-1 in contrast with the color of the background area 202 may indicate the result of the test. A portion of the background area 202 may include the area immediately outside the circumference of each test area 210a-1.

The field of view 204a-b may be defined by the camera 106 and the lens. The field of view may define the boundary of the captured two-dimensional image. The field of view 204a-b may determine the number of test areas 210a-1 to be read for a given captured image. The field of view 204a-b may encompass any number of samples.

In an embodiment, the camera 106 may capture multiple images for a given field of view 204a-b. The field of view 204a-b may be moved to encompass different test areas 210a-1. For example, the receiving area 112 may be adapted to move from a first position to a second position relative to the camera 106. Similarly, the camera 106 may be adapted to move relative to the receiving area 112. Thus, a first field of view 204a may be associated with the first position; and a second field of view 204b may be associated with the second position. The first field of view 204a may encompass a first subset 210a-f of test areas 210a-1. The second field of view 204b may encompass a second subset 210d-i of test areas 210a-1. One or more two-dimensional images may be captured for each field of view 204a-b. A cycle of capturing images and moving the assay 104 may be repeated such that each test area 210a-1 has been captured in an image.

The system 102 may introduce a time delay between each captured image and between each different field of view 204a-b. Thus, each field of view may represent multiple patients and/or different time points. The system 102 may capture multiple determinations of the test areas 210a-1 at multiple points in time. The readings as a function of time may decrease variations in the result of the test and may increase the overall signal-to-noise ratio. Having multiple reacted reagent areas in each image may also reduce positioning error and interference associated with position tolerance. The background areas may serve to calibrate the image analysis for variations in the texture and color of the assay 104.

FIG. 3A depicts an exemplary uniform field illuminator 108 in side view with camera 106. FIG. 3B depicts an exemplary uniform field illuminator 108 and in frontal view without the camera 106 shown. As shown in FIG. 3A, the uniform field illuminator 108 may include one or more white LED's 302. The one or more white LED's 302 may provide illumination of assay 104. For example, as shown in FIG. 3B, the uniform field illuminator 108 may include a ring of eight white LED's 302 alternating with red LED's 308 and/or infrared (IR) LED's 306. The red LED's 308 may be used to fill in weak aspects of the spectrum associated with white LED's 302. The IR LED's 306 may be used to calibrate the camera 106's IR response. The uniform field illuminator 108 may be adapted to selectively illuminate each white LED 302, IR LED 306, and/or red LED 308. For example, the uniform field illuminator 108 may illuminate the IR LED's 306 to capture a IR calibration image. In an embodiment, reflectance outside the normal visual range may be used as a constant reference value. This constant reference may be used to reduce interferences introduced by irregularities in the texture and height differences between different test surfaces of dry reagent assays. CCD image capture devices may be sensitive to IR. The IR illumination may be turned off when measuring a color response. Turning off the IR illumination when measuring color response may avoid saturation.

The uniform field illuminator 108 may provide a generally flat, white light illumination within which portions of the illumination field may be above and/or below the average intensity. Areas above and/or below the average intensity may include noise which may result in an uneven signal-to-noise ratio within the areas above and/or below average intensity. Areas above and/or below the average intensity may be calibrated out using filters according to a calibration image. The calibration image may include a standard color card that contains one or more specific areas of color. For example, the color card may include 24 individual colors. Images captured of the color card may be used to calibrate the color translation of the camera 106. For example, images captured of the color card may be used to calibrate how the CCD translates various wavelengths of light into pixel RGB values.

In addition to color response, overall luminance may be calibrated as well. A calibration grey scale reflectance standard may be used to establish a calibration curve. For example, Munsell values may be used as reference values for the various gray scales. Captured images may be compared to the reference value to assess and calibrate the luminance linearity of the camera 106. The gamma characteristic of a camera 106 may adjust the luminance linearity of the camera 106 as compared to a reference. The gamma value may be set in a nonlinear value to calibrate the camera 106.

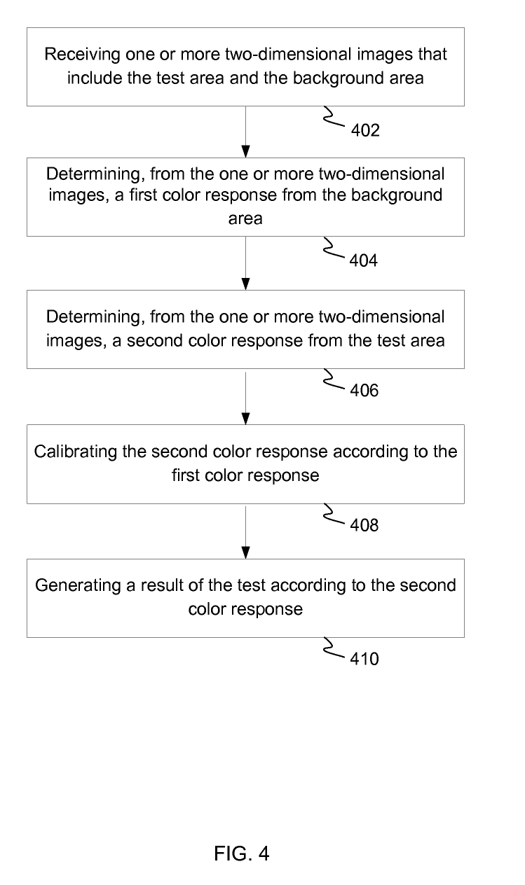

FIG. 4 depicts an exemplary process flow for reading an assay 104. At 402, the processor 110 may receive one or more two-dimensional images that include a test area 210a-1 and at least a portion of the background area 202. Each two-dimensional image may include both the test area 210a-1 and the background area 202. For example, the background area 202 may include the area of unreacted reagent immediately exterior to the circumference of the test area 210a-1.

The one or more two-dimensional images may be received from the camera 106. The camera 106 may capture the one or more two-dimensional images while the assay 104 is illuminated by the uniform field illuminator 108. In an embodiment, the processor 110 may direct the uniform field illuminator 108 to illuminate the assay 104 with a sequence of frequencies of light. The processor 110 may direct the camera 106 to capture a sequence of images corresponding to the sequence of frequencies of light. In an embodiment, the processor 110 may direct the uniform field illuminator 108 to illuminate the assay 104 with a substantially uniform level of white light. In an embodiment, the processor 110 may direct the uniform field illuminator 108 to illuminate the assay 104 with infrared light.

The camera 106 may capture the one or more two-dimensional images while the field of view is positioned in more than one position relative to the assay 104. For example, the processor 110 may direct the receiving area 112 to position the assay 104 in a first position relative to the camera 106 such that a first subset 210a-f of test areas 210a-1 are encompassed within the field of view. The processor 110 may direct the receiving area 112 to position the assay 104 in a second position relative to the camera 106 such that a second subset 210d-i of test areas 210a-1 are encompassed within the field of view.

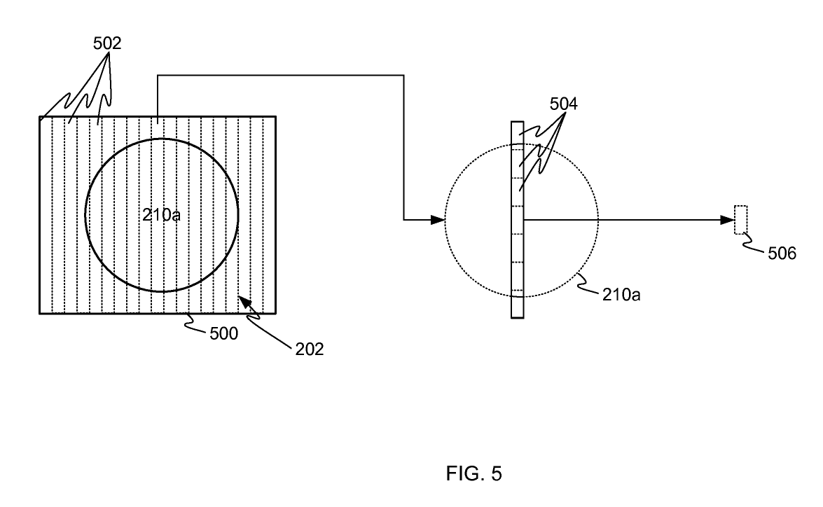

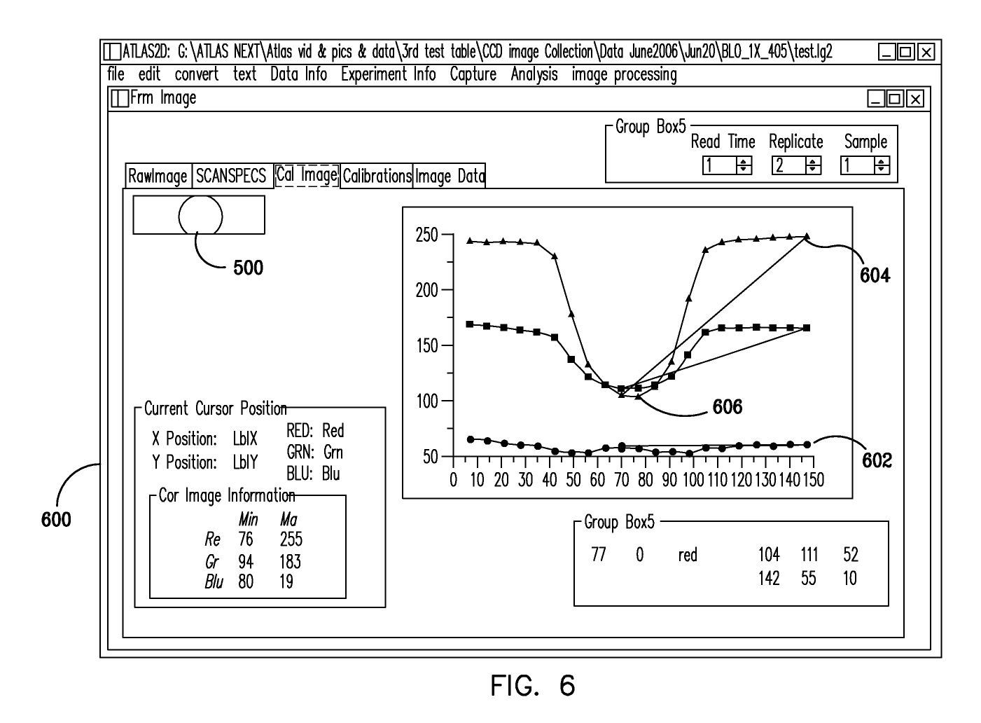

At 404, the processor 110 may determine from the one or more two-dimensional images a first color response from the background area 202. The first color response may be a corresponding red-green-blue value. The processor 110 may crop the one or more two-dimensional images to limit the processing to one test area 210a-1. Where the one or more two-dimensional images includes a plurality of test areas 210a-1 associated with each image, the processor 110 may crop each test area 210a-1 for processing separately. At 406, the processor 110 may determine, from the one or more two-dimensional images, a second color response from the test area 210a-1. The processor 110 may determine the second color response by determining the respective color response for each two-dimensional image and averaging a color response values. The processor 110 may determine the second color response by combining one or more of the two-dimensional images into a composite image and determining the second color response from the test area 210a-1 represented in the composite image. The processor 110 may determine the region of the two-dimensional image associated with the background area 202 and the region of the two-dimensional image associated with the test area 210a-1 by converting the two-dimensional image into a graph and determining maximum and minimum points on that graph (see FIGS. 5 and 6).

At 408, the processor 110 may calibrate the second color response according to the first color response. In an embodiment, the processor 110 may determine the difference between the red-green-blue value of the second color response with that of the first color response. In an embodiment, the processor 110 may normalize the second color response according to the first color response.

At 410, the processor 110 may generate a result of the test according to the second color response. The second color response may correspond to the level of reaction between the sample and the reagent. The processor 110 may compare the second color response to known color responses known to indicate the presence or absence of a compound and/or a characteristic of a biological sample. In an embodiment, a standard solution may be dispensed on one or more of the test areas 210a-1, and generating a result may include comparing the second color response to that of the standard solution. Generating a result may include presenting the result to a user. The result may be presented via a graphical user interface (See FIG. 6).

FIG. 5 depicts an exemplary process for determining a color response from a reacted area of reagent. A two-dimensional image 500 may be cropped to include a test area 210a and a background area 202. The two-dimensional image may be smoothed. In an embodiment, the two-dimensional image may be smoothed by reducing the data by averaging 3×3 pixel areas.

The two-dimensional image 500 may be subdivided in the x-direction into a plurality of columns 502. The processor 110 may determine an average red-green-blue value for each column 502 of constant pixel width. To illustrate, a two-dimensional image 500 may be 140 pixels wide and 120 pixels tall. The illustrative two-dimensional image 500 may be subdivided into fourteen 10 pixel wide columns. The darkest (i.e. with the most pronounced color values) column 502 may be determined The darkest column 502 may have the lowest combined red-green-blue value. Generally, the darkest column 502 may be at the center of the test area 210a.

The darkest column 502 may become the starting point for a second image scan. The darkest column 502 may be subdivided into a plurality of sections 504. An average red-green-blue value may be determined for each section. To illustrate, the darkest column 502 may be 120 pixels tall and 10 pixels wide. The illustrative darkest column 502 may be subdivided into twelve 10×10 sections. The darkest section 506 may be determined The darkest section 506 may have the lowest combined red-green-blue value. Generally, the darkest section 506 may be at the center of the test area 210a.

The second color response from the test area 210a may be a value associated with the red-green-blue value determined for the darkest section 506. The first color response from the background area 202 may be a value associated with the red-green-blue value associated with the image regions outside of the test area 210a.

FIG. 6 depicts an exemplary user interface 600 for outputting, for example in a display format, a result from reading an assay 104. The user-interface 600 includes a cropped two-dimensional image 500 and a graph 602 depicting the average red-green-blue values for the plurality of columns 502 that subdivided the cropped image 500 from left to right, for example. The graph 602 may represent a maximum 604 and minimum 606 read-green-blue value. The red-green-blue values associated with the left-hand-side and the right-hand-side columns may correspond to the red-green-blue values of the background area 202. The red green blue values associated with the center columns may correspond to the red-green-blue values of the test area 210a. Thus, the first color response for the background area 202 may be determined from the left-hand side and the right-hand side red-green-blue values. The second color response for the test area 210a may be determined from the center red-green-blue values. The second color response may be calibrated according to the first color response.

The information presented in the graph 602 may be used to assess the result of the test for which the assay 104 is being used. For example, the calibrated second color response may be compared to a known value and/or known threshold associated with a positive or negative result of the test. Also for example, the calibrated second color response can be compared to a known function relating the calibrated second color response to a value and/or level associated with a compound and/or a characteristic of the biological sample.

To illustrate, the calibrated second color response may be associated with a pH value of the sample. Generally, the known function may be determined through testing known samples of known pH values to relate a given calibrated second color response to a pH value. The two-dimensional images, red-green-blue values, results, calibration information, and test information such as patient name and test identification may, and environmental data may be engaged via the user interface and may be stored in the datastore and/or presented to the user.

The system 102 may enable reading small test areas of reacted reagent by overcoming the limited amount of signal and the increased noise associated with small test areas. Small test areas may improve the economics in a commercial implementation and may reduce the amount of sample required for a given test. Given the challenges associated with additional noise and limited signal in small test areas of reacted reagent, the disclosed combination of elements would not be obvious to try by one of ordinary skill in the art and would not yield predictable results.

While the present invention has been described in connection with the exemplary embodiments of the various figures, it is not limited thereto and it is to be understood that other similar embodiments may be used or modifications and additions may be made to the described embodiments for performing the same function of the present invention without deviating therefrom. Furthermore, it should be emphasized that a variety of computer platforms, including handheld device operating systems and other application specific operating systems are contemplated. Still further, the present invention may be implemented in or across a plurality of processing chips or devices, and storage may similarly be implemented across a plurality of devices. Therefore, the present invention should not be limited to any single embodiment, but rather should be construed in breadth and scope in accordance with the appended claims. Also, the appended claims should be construed to include other variants and embodiments of the invention, which may be made by those skilled in the art without departing from the true spirit and scope of the present invention.

What is claimed:

1. A system for reading an assay, the assay having a dry reagent that defines a test area and a background area; the assay being used as a test for a reaction between a sample and the reagent, the test area of the reagent being in contact with the sample, the system comprising:
a camera that simultaneously captures a first two-dimensional image of the test area and the background area; and
a processor that determines, from the first two-dimensional image, a first color response from the background area and a second color response from the test area, calibrates the second color response according to the first color response, and generates a result of the test according to the second color response.

2. The system of claim 1, wherein the camera is a charge-coupled device (CCD) camera.

3. The system of claim 1, wherein the CCD camera has a resolution of about 0.01 mm² to about 0.5 mm² per pixel.

4. The system of claim 1, wherein the test area is substantially circular with a diameter between about 0.1 mm and about 5 mm.

5. The system of claim 1, wherein the test area is substantially rectangular.

6. The system of claim 5, wherein the test area has an area of about 0.008 mm² to about 20 mm².

7. The system of claim 1, further comprising a uniform field illuminator that provides a substantially uniform level of illumination across the test area and the background area.

8. The system of claim 7, wherein the camera captures an IR calibration image while the assay is illuminated with infrared light, and wherein the processor normalizes the two-dimensional image with the IR calibration image.

9. The system of claim 7, wherein the uniform field illuminator is in communication with the processor, wherein the processor directs the uniform field illuminator to illuminate the test surface with a sequence of frequencies of light, and wherein the processor directs the camera to capture a sequence of images corresponding to the sequence of frequencies of light.

10. The system of claim 7, wherein the processor determines the second color response from the sequence of images.

11. The system of claim 7, wherein the uniform field illuminator comprises a circular array of light emitting diodes around the camera.

12. The system of claim 8, wherein the circular array of light emitting diodes may emit any light with a wavelength of about 400 nm to about 1500 nm.

13. The system of claim 1, wherein the camera captures a linearity calibrating image and the processor adjusts the gamma function of the camera according to the linearity calibrating image.

14. The system of claim 1, wherein the camera captures a second two-dimensional image of the test area and the background area, and wherein the processor arithmetically alters the first two-dimensional image with information from the second two dimensional image.

15. The system of claim 14, wherein the processor alters the first two-dimensional image with information from the second two dimensional image by averaging data from the first and second two-dimensional images.

16. The system of claim 14, wherein the camera captures the first and second two-dimensional image at a rate about 90 frames per second.

17. The system of claim 1, wherein the processor smoothes the first two-dimensional image with a filter.

18. The system of claim 1, wherein the processor determines the first color response by segmenting the first two-dimensional image into a plurality of columns, determining a first column from the plurality of columns that has the greatest color response, segmenting the first column into a plurality of sections, and determining a first section from the plurality of sections that has the greatest color response.

19. The system of claim 1, wherein the camera defines a focused field of view and further comprising a receiving area that positions the assay such that the test area and the background area are within the focused field of view.

20. The system of claim 18, wherein the receiving area is adapted to receive any of a strip, cassette, and card assay format.

21. A system for reading an assay; the assay having a dry reagent that defines a plurality of test areas separated by a background area; the assay being used as a test for a reaction between a sample and the dry reagent, system comprising:
a camera that captures a plurality of two-dimensional images, wherein at least a first two-dimensional image of the plurality of two-dimensional images includes the background area and a first subset of the plurality of test areas; and
a processor that determines, from the plurality of two-dimensional images, a first color response of the background area and a plurality of respective second color responses corresponding to the first subset of the plurality of test areas, calibrates the plurality of respective second color responses according to the first color response, and generates a first plurality of respective results according to the plurality of respective second color responses.

22. The system of claim 21, wherein the camera defines a field of view and further comprising a receiving area that positions the assay in a first position such that the first subset of the plurality of test areas and the background area are within the field of view.

23. The system of claim 21, wherein the receiving area is adapted to move the assay from the first position to a second position such that a second subset of the plurality of test areas and the background area are within the field of view, and wherein at least a second two-dimensional image of the plurality of two-dimensional images includes the background area and the second subset of the plurality of test areas.

24. The system of claim 23, wherein the processor determines a plurality of respective third color responses corresponding to the second subset of the plurality of test areas, calibrates the plurality of respective third color responses according to the first color response, and generates a second plurality of respective results according to the plurality of respective third color responses.

25. The system of claim 21, wherein the camera is a charge-coupled device (CCD) camera.

26. The system of claim 21, wherein the CCD camera has a resolution of about 0.01 mm² to about 0.5 mm².

27. The system of claim 21, wherein each test area is substantially circular with a diameter between about 0.1 mm and about 5 mm.

28. The system of claim 21, wherein each test area is substantially rectangular.

29. The system of claim 28, wherein each test area has an area of about 0.008 mm² to about 20 mm².

30. The system of claim 21, further comprising a uniform field illuminator that provides a substantially uniform level of illumination across the plurality of test areas and the background area.

31. The system of claim 30, wherein the camera captures a IR calibration image while the assay is illuminated with infrared light, and wherein the processor normalizes the plurality of two-dimensional images with the IR calibration image.

32. The system of claim 30, wherein the uniform field illuminator is in communication with the processor, wherein the processor directs the uniform field illuminator to illuminate the plurality of test areas with a sequence of frequencies of light, and wherein the processor directs the camera to capture the plurality of two-dimensional images according to the sequence of frequencies of light.

33. The system of claim 30, wherein the uniform field illuminator comprises a circular array of light emitting diodes around the camera.

34. The system of claim 30, wherein the circular array of light emitting diodes may emit any light with a wavelength of about 400 nm to about 1500 nm.

35. The system of claim 21, wherein the camera captures a linearity calibrating image, and the processor adjusts the gamma function of the camera according to the linearity calibrating image.

36. The system of claim 21, wherein the camera captures the plurality of two-dimensional images at a rate about 90 frames per second.

37. A computer readable medium for reading an assay, the assay having a dry reagent that defines a test area and a background area; the assay being used as a test for a reaction between a sample and the reagent, the test area of the reagent being in contact with the sample, the computer-readable medium having computer instructions stored thereon that when executed perform a method comprising:
receiving a plurality of two-dimensional images that include the test area and the background area;
determining, from the plurality of two-dimensional images, a first color response from the background area;
determining, from plurality of two-dimensional images, a second color response from the test area;
calibrating the second color response according to the first color response; and
generating a result of the test according to the second color response.

38. The computer readable medium of claim 37, wherein determining a second color response from the test area comprises averaging a plurality of raw color responses corresponding to the respective test area of each of the plurality of two-dimensional images.

39. The computer readable medium of claim 37, wherein determining a second color response from the test area comprises averaging the plurality of two-dimensional images to a composite image, the composite image having a composite test area, and determining the second color response from the composite test area.

40. The computer readable medium of claim 37, smoothing the plurality of two-dimensional images with a filter.

41. The computer readable medium of claim 37, further comprising segmenting a first two-dimensional image of the plurality of two-dimensional images into a plurality of columns to determine the second color response, determining a first column from the plurality of columns that has the greatest color response, segmenting the first column into a plurality of sections, and determining a first section from the plurality of sections that has the greatest color response.
